(19) United States
(12) Patent Application Publication
(10) Pub. No.: US 2011/0087524 A1
(43) Pub. Date: Apr. 14, 2011

(54) DETERMINING TRAVEL ROUTES BY USING FEE-BASED LOCATION PREFERENCES

(75) Inventors: Gregory Jensen Boss, Saginaw, MI (US); Rick Allen Hamilton, II, Charlottesville, VA (US); Jacquelyn Annette Martino, Cold Spring, NY (US); Clifford Alan Pickover, Yorktown Heights, NY (US); Anne R. Sand, Peyton, CO (US)

(73) Assignee: INTERNATIONAL BUSINESS MACHINES CORPORATION, Armonk, NY (US)

(21) Appl. No.: 12/578,627

(22) Filed: Oct. 14, 2009

(51) Int. Cl. G01C 21/00; G06Q 30/00

(52) U.S. Cl. 705/14.1; 701/200

(57) ABSTRACT

A method and system for determining a travel route that includes a location as a result of fee-based preferential weighting. A user request is received for determining a route from point A to point B. A preferential weight is assigned to a location associated with a vendor. The location is selected as being capable of being included along the route. Selecting the location is based on the request and preferential weight. A fee to be charged to the vendor is determined. The fee is for presenting the route to the user as a recommended route and is based on the location being included along the recommended route. The route is determined so that the location is included along the route. The route is presented to the user as the recommended route.

### FIELD OF THE INVENTION

The present invention relates to a data processing method and system for providing a location preference in a routing algorithm, and more particularly to technique for determining travel routes that take into account fee-based preferential weighting of locations.

### BACKGROUND OF THE INVENTION

With an increased use of Global Positioning System (GPS) units to determine travel routes, travelers are following routes recommended to them, rather than using maps or following familiar paths. Conventional route planning systems determine optimal routes based on different preferred conditions, including minimizing travel time or minimizing the distance traveled. By focusing on optimal route determination, the known route planning systems fail to consider non-optimal routes whose presentation to travelers may have value to other parties. Thus, there exists a need to overcome at least one of the preceding deficiencies and limitations of the related art.

### SUMMARY OF THE INVENTION

In one or more embodiments, the present invention provides a computer-implemented method of determining a route that includes a location according to a fee charged to an entity associated with the location. The method comprises:

receiving a request from a user for a determination of a route from a first point to a second point;

assigning a preferential weight to a location associated with a vendor;

selecting the location as being capable of being included along the route, wherein selecting the location is based on the request and the preferential weight;

determining a fee to be charged to the vendor for presenting the route to the user as a recommended route, wherein the fee is based on the location being included along the recommended route;

a processor of a computer system determining the route so that the location is included along the route; and

presenting the determined route to the user as the recommended route.

A system, program product and process for supporting computing infrastructure corresponding to the above-summarized method is also described and claimed herein.

The present invention provides a technique for presenting travel routes to travelers, where the routes are generated so as to include locations preferentially weighted in a routing algorithm according to fees charged to vendors associated with the locations.

### BRIEF DESCRIPTION OF THE DRAWINGS

FIG. 1 is a block diagram of a system for determining a travel route that includes a location according to a fee charged to an entity associated with the location, in accordance with embodiments of the present invention.

FIG. 2 is a flowchart of a process for determining a travel route in the system of FIG. 1, where the process includes a location in the travel route according to a fee charged to an entity associated with the location, in accordance with embodiments of the present invention.

FIG. 3 is a flowchart of a process for determining an additional fee based on an actual route taken subsequent to a presentation of a recommended route in the process of FIG. 2, in accordance with embodiments of the present invention.

FIG. 4 is a flowchart of a process for determining a travel route according to the process of FIG. 2 and based on a rule that limits the distance of the recommended route, in accordance with embodiments of the present invention.

FIG. 5 is a flowchart of a process for determining a travel route according to the process of FIG. 2 and based on a rule that limits the number of recommended routes that pass through a constrained area.

FIG. 6 is a computer system that is included in the system of FIG. 1, implements the process of FIG. 2, and may optionally implement one or more of the processes of FIG. 3, FIG. 4 and FIG. 5, in accordance with embodiments of the present invention.

### DETAILED DESCRIPTION OF THE INVENTION

### Overview

Embodiments of the present invention provide location preference in routing algorithms. The present invention may recommend a travel route so as to include a given location within the route, and more specifically, to include a business or other organization whose name or type is specified in the routing algorithm. In one embodiment, a vendor or other organizational entity is charged a fee to direct a routing system to preferentially weight a particular location in a routing algorithm, thereby causing the routing system to display a recommended route that passes by the particular location. In another embodiment, a route calculation service utilizes an algorithm that takes into account a user's profile information to determine advertising fees. In still another embodiment, additional route generation rules and/or user-specified parameters may be applied to generate travel routes based on multiple criteria.

### System for Determining a Route by Using a Fee-Based Location Preference

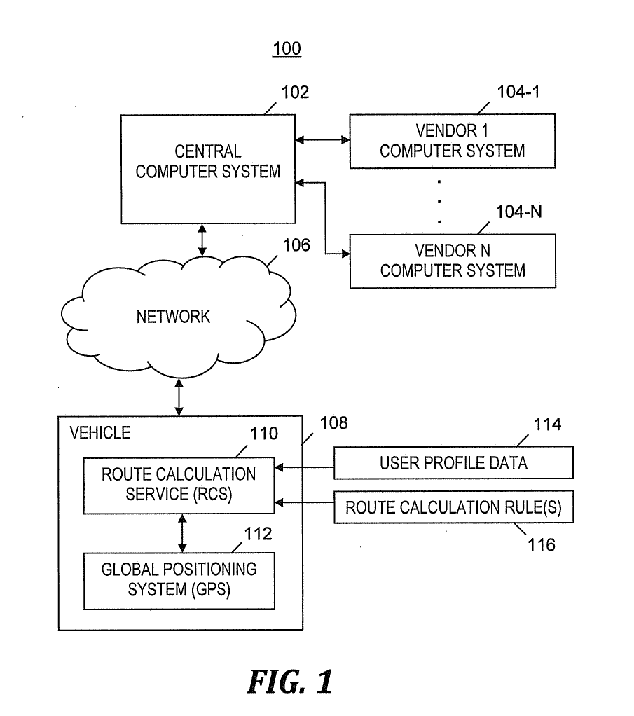

FIG. 1 is a block diagram of a system for determining a travel route that includes a location as a result of a fee charged to an entity associated with the location, in accordance with embodiments of the present invention. System 100 includes a central computer system 102, vendor computer systems 104-1 . . . 104-N, a network 106, and a vehicle 108 that includes a software-implemented route calculation service (RCS) 110 and a global positioning system (GPS) 112. System 100 may also include optional user profile data 114 and one or more optional route calculation rules 116. User profile data 114 and route calculation rules 116 may be stored in a computer data storage unit coupled to central computer system 102 or coupled to a data processing unit (e.g., GPS 112) residing in vehicle 108.

Vendor computer systems 104-1 . . . 104-N are managed by vendors 1 . . . N, respectively, where N≧1. The present invention contemplates that the vendors 1 . . . N may include one or more businesses and/or one or more other types of organizational entities. Vendor computer systems 104-1 . . . 104-N send identifications of vendors 1 . . . N and identifications of multiple locations to central computer system 102 to indicate that vendors 1 . . . N may participate in a fee-based location preference system managed by central computer system 102. Each vendor in vendors 1 . . . N is associated with one or more locations of the aforementioned multiple locations. For example, if Vendor 1 is associated with Location 1 and Vendor 1 is the owner of a grocery store, then Location 1 may be the site of the grocery store.

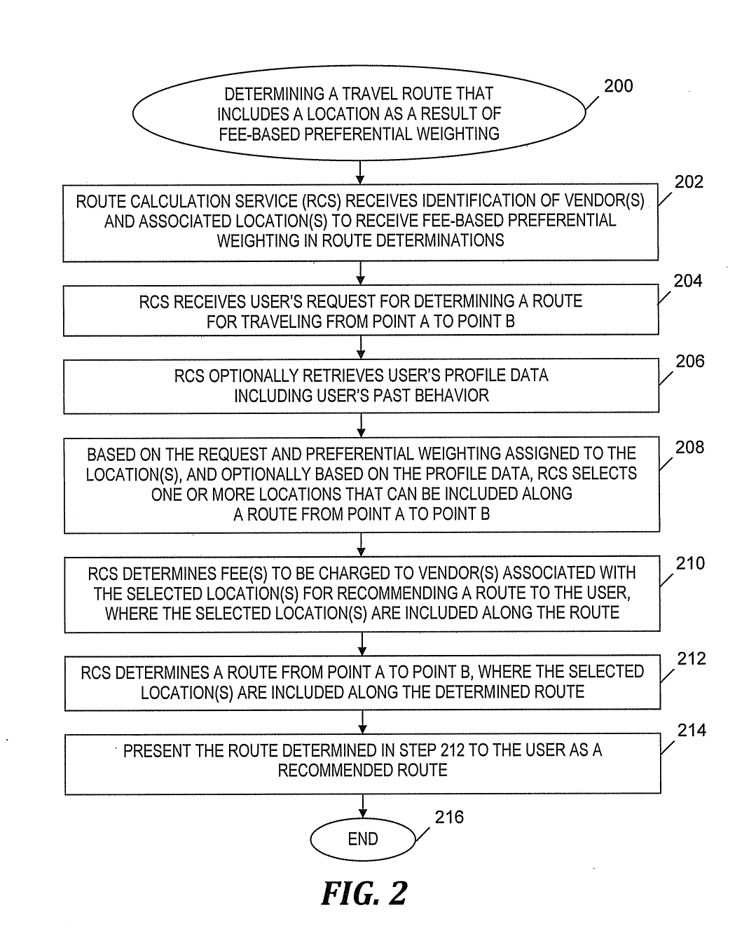

RCS 110 receives the identifications of the vendors 1 . . . N and the identifications of the multiple locations from central computer system 102 via network 106. RCS 110 determines a travel route that includes a location associated with a vendor included in vendors 1 . . . N and RCS 110 determines a fee to be charged to the vendor. In one embodiment, the central computer system 102 receives indications from multiple route calculation services in multiple vehicles (e.g., route calculation service 110 in vehicle 108 and other route calculation services in other vehicles not shown in FIG. 1) of which vendors are being charged a fee and notifies the vendor computer systems of computer systems 104-1 . . . 104-N that are managed by the vendors being charged the fee. The determination of the travel route may also be based on user profile data 114 and/or route calculation rules 116. Further descriptions of the functionality of components of system 100 are found in the discussions below relative to FIGS. 2-5.

### Process for Determining a Route by Using a Fee-Based Location Preference

FIG. 2 is a flowchart of a process for determining a travel route in the system of FIG. 1, where the process includes a location in the travel route as a result of a fee charged to an entity associated with the location, in accordance with embodiments of the present invention. The process of determining a travel route in the system of FIG. 1 starts at step 200. In step 202, RCS 110 (see FIG. 1) receives identifications of vendor(s) and location(s) associated with the vendor(s), where the location(s) may be assigned fee-based preferential weight(s) in route determinations. That is, RCS 110 (see FIG. 1) receives an identification of each vendor who may be charged a fee so that a location associated with the vendor is assigned a preferential weight to be included in a travel route determined by the RCS. In one embodiment, the location associated with the vendor is a site (e.g., identified by address or geographic coordinates) at which the vendor conducts business.

In step 204, RCS 110 (see FIG. 1) receives a request issued by a user of GPS 112 (see FIG. 1) for a travel route for vehicle 108 (see FIG. 1) to travel from a first geographic location (a.k.a. point A or first point) to a second geographic location (a.k.a. point B or second point).

Although not shown in FIG. 2, the user may indicate that she/he wants to participate in the remaining process of FIG. 2 (i.e., the steps that follow step 204), or the user may opt-out of the remaining process of FIG. 2, thereby causing a route to be recommended that is not based on the preferential weight and user profile data described below.

In step 206, RCS 110 (see FIG. 1) optionally retrieves user profile data that describes the user who issued the request in step 204. The user profile data includes data describing the user's past behavior and may also include predicted future behavior of the user. The user profile data may include one or more preferences that a user has for purchasing one or more particular goods and/or one or more particular services, where the preference(s) may be based on, for example, past purchases made by the user and/or user-specified selections of goods and/or services.

Prior to step 208 and subsequent to step 202, RCS 110 (see FIG. 1) assigns a preferential weight to each location whose identification is received in step 202. The preferential weight is used by a routing algorithm implemented in RCS 110 (see FIG. 1) to give preference to selecting a route from multiple routes that satisfy the request received in step 204, where the selected route includes one or more locations that were assigned the preferential weight. In step 208, based on the request received in step 204, based on the preferential weight assigned to the location(s) whose identifications are received in step 202, and optionally based on the user profile data retrieved in step 206, RCS 110 (see FIG. 1) selects one or more locations of the location(s) whose identifications are received in step 202. A routing algorithm implemented by RCS 110 (see FIG. 1) can include the one or more locations selected in step 208 along a route from point A to point B in the route requested in step 204.

In step 210, RCS 110 (see FIG. 1) determines one or more fees to be charged to one or more vendors associated with the one or more locations selected in step 208. The one or more fees are for recommending a route to the user, where the recommended route conforms to the request received in step 204, and where the one or more locations selected in step 208 are included along the recommended route. As used herein, a location included along a route from a first point to a second point is defined as a location whose address is on the route and is not the first point and is not the second point. As used herein, a fee is defined as a charge to or a payment made by a vendor for a location associated with the vendor being included in a route, where the charge or payment is not the result of a bid in an auction. In one embodiment, the fee is predetermined by an entity that controls the RCS 110 (see FIG. 1).

In one embodiment, step 210 includes determining multiple fees, each fee being charged to a corresponding vendor of multiple vendors. The multiple vendors may collectively agree to pay the multiple fees so that a route determined by RCS 110 (see FIG. 1) includes multiple locations associated with the multiple vendors. The multiple fees may all be the same fee amount or may include different fee amounts.

In step 212, RCS 110 (see FIG. 1) determines a route from point A to point B that conforms to the request received in step 204 and that is preferred according to the preferential weight assigned to the one or more locations selected in step 208. The determination of the route in step 212 may also be based on user profile data optionally retrieved in step 206. The one or more locations selected in step 208 are included along the route determined in step 212.

In one embodiment, the user is notified if user profile data is a basis for the route determined in step 212. In another embodiment, the user is not notified if user profile data is a basis for the route determined in step 212.

In step 214, RCS 110 (see FIG. 1) instructs a data processing system (e.g., GPS 112 in FIG. 1) residing in vehicle 108 (see FIG. 1) that the route determined in step 212 is to be presented to the user. In response, the data processing system (e.g., GPS 112 in FIG. 1) presents (e.g., displays) the route determined in step 212 to the user as a recommended route. The process of FIG. 2 ends at step 216.

In an alternate embodiment, instead of having the RCS 110 (see FIG. 1) push a route, a user may pull a route based on explicit user profile data items being specified for a particular trip event that requires a travel route to be determined and recommended. For example, the user may specify a distance beyond the length of the shortest route that the user is willing to travel. As another example, the user may specify service(s) and/or product(s) (e.g., grocery store) the user would like to travel near during a given trip. The route determined in step 212 would include location(s) selected in step 208, but would be further based on including one or more locations that provide the service(s) and/or product(s) specified by the user.

Possible methods for funding and for providing optional incentives for the process in FIG. 2 may include:
1. A fee is charged to a vendor whose location is included in the recommended route and the user who is a customer of the vendor is not compensated.
2. The user (i.e., the customer of the vendor whose location is included in the recommended route) is compensated directly (e.g., with cash, reimbursements for tolls incurred along the route, credits for spending at the vendor's store, etc.) to encourage the user's participation in the process of FIG. 2.
3. Compensation may optionally be given to third parties that promote nonprofit causes, including charities or green initiatives. Compensation to such third parties may also encourage the user's participation in the process of FIG. 2.
4. A sliding scale of fees, so that payment of a higher fee increases the preference weight assigned to a location, thereby increasing the likelihood that a recommended route will include the location.

### Additional Fee Based on Actual Route Taken

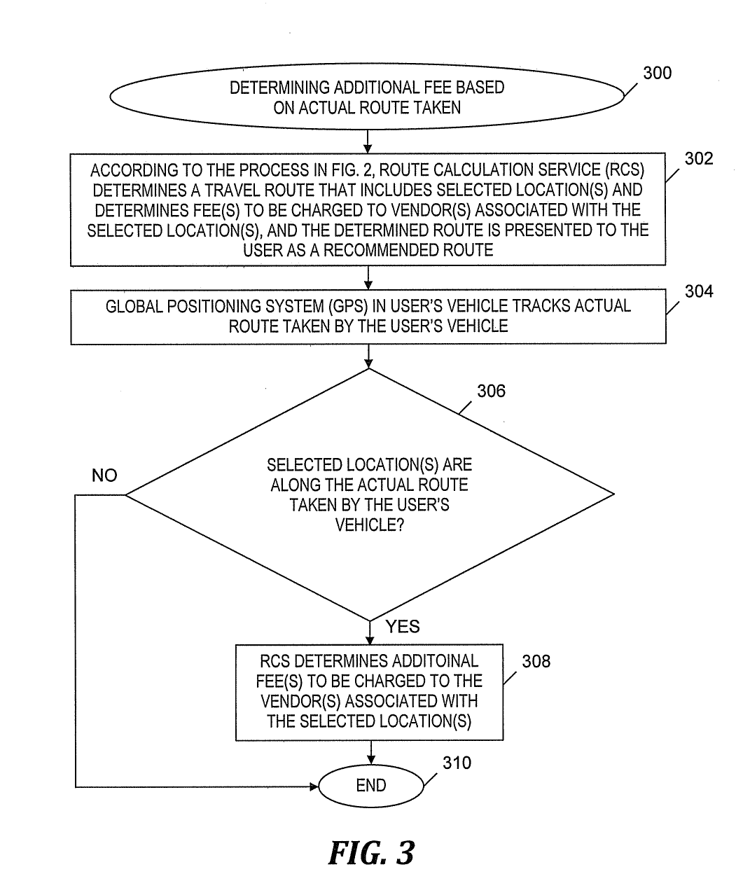

FIG. 3 is a flowchart of a process for determining an additional fee based on an actual route taken subsequent to a presentation of a recommended route in the process of FIG. 2, in accordance with embodiments of the present invention. The additional fee determination process of FIG. 3 starts at step 300. In step 302, following the steps of the process of FIG. 2, RCS 110 (see FIG. 1) deter nines a travel route that includes selected location(s) and determines fee(s) to be charged to vendor(s) associated with the selected location(s), and the determined travel route is presented to the user as a recommended route.

In step 304, GPS 112 (see FIG. 1) located in the user's vehicle 108 (see FIG. 1) tracks the actual route taken by the user's vehicle.

In step 306, RCS 110 (see FIG. 1) determines whether the selected location(s) are along the actual route traveled by the user in vehicle 108 (see FIG. 1). In one embodiment, step 306 includes RCS 110 (see FIG. 1) determining whether the actual route traveled by vehicle 108 (see FIG. 1) is the recommended route determined in step 302.

If step 306 determines that the selected location(s) are along the actual route taken by vehicle 108 (see FIG. 1), then in step 308 RCS 110 (see FIG. 1) determines additional fee(s) to be charged to the vendor(s) associated with the selected location(s). For example, if the fee determined in step 210 (see FIG. 2) to be charged to Vendor 1 is X and an additional fee determined in step 308 to be charged to Vendor 1 is A, then the total fee charged to Vendor 1 is X+A.

Different vendors may be charged the same or different additional fees, where the additional fees are determined in step 308.

Following step 308, the process of FIG. 3 ends at step 310. Returning to step 306, if RCS 110 (see FIG. 1) determines that the selected location(s) are not along the actual route taken by vehicle 108 (see FIG. 1), then the process of FIG. 3 ends at step 310.

### Rule Limiting the Distance of a Recommended Route

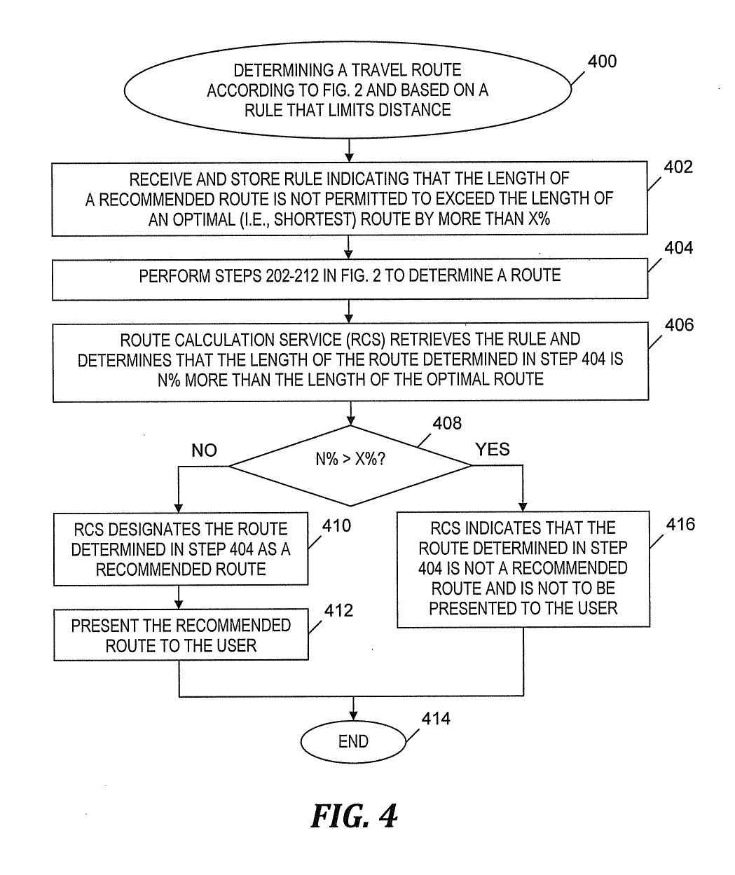

FIG. 4 is a flowchart of a process for determining a travel route according to the process of FIG. 2 and based on a rule that limits the distance of the recommended route, in accordance with embodiments of the present invention. The process of FIG. 4 begins at step 400. In step 402, one or more route calculation rules 116 (see FIG. 1) are received and stored in a computer data storage unit. The computer data storage unit may be coupled to GPS 112 (see FIG. 1) or computer system 102 (see FIG. 1). The received route calculation rule(s) 116 (see FIG. 1) include a distance-limiting rule that indicates that the length of a recommended route from point A to point B presented in the process of FIG. 2 is not permitted to exceed the length of an optimal (i.e., shortest) route from point A to point B by more than X %.

In step 404, steps 202, 204, 206, 208, 210 and 212 in the process of FIG. 2 are performed by RCS 110 (see FIG. 1) to determine a route from point A to point B.

In step 406, RCS 110 (see FIG. 1) retrieves the distance-limiting rule from the aforementioned computer data storage unit. Also in step 406, RCS 110 (see FIG. 1) determines that the length of the route determined in step 404 is N % more than the length of the optimal route from point A to point B.

If RCS 110 (see FIG. 1) determines in step 408 that N % is not greater than X %, then the No branch of step 408 is taken and step 410 is performed. In step 410, RCS 110 (see FIG. 1) designates the route determined in step 404 as a recommended route. In step 412, the GPS 112 (see FIG. 1) presents (e.g., displays) the recommended route to the user. The process of FIG. 4 ends at step 414.

Returning to step 408, if RCS 110 (see FIG. 1) determines that N % is greater than X %, then in step 416 the RCS indicates that the route determined in step 404 is not a recommended route and is not to be presented to the user. Following step 416, the process of FIG. 4 ends at step 414.

In an alternate embodiment, the rule received in step 402 indicates that the length of the recommended route is not permitted to exceed the length of the optimal route by more than a distance X (e.g., X miles) and step 406 determines that the length of the route determined in step 404 is a distance N longer than the length of the optimal route. Furthermore, in this alternate embodiment, step 408 determines whether N>X.

### Rule Limiting the Number of Recommended Routes

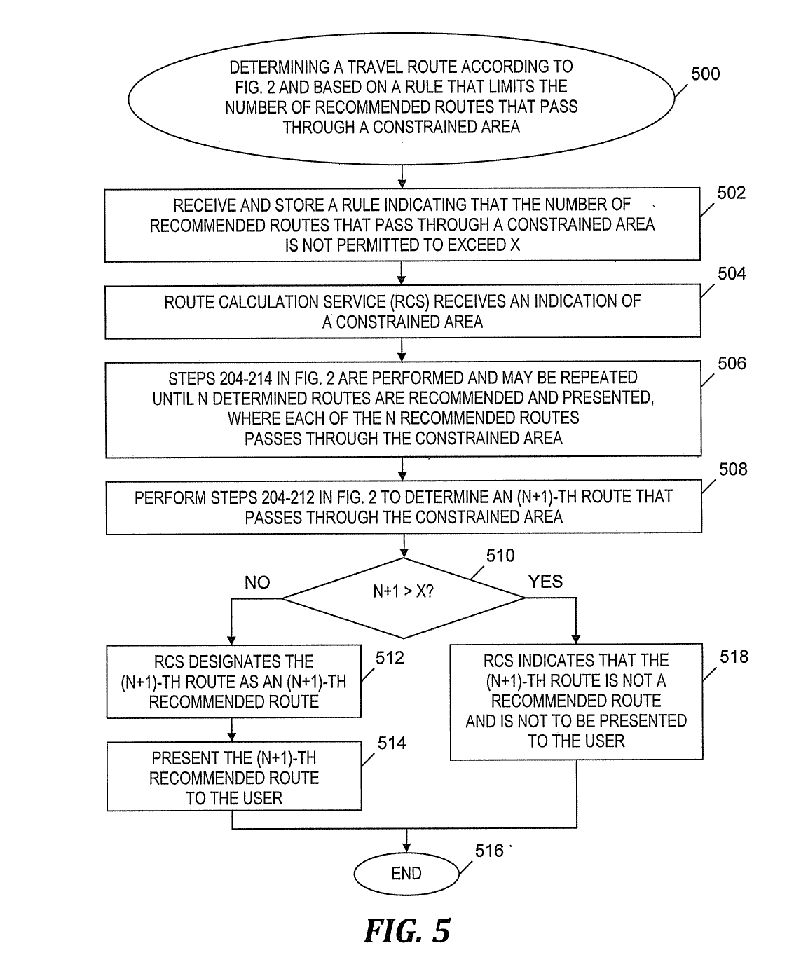

FIG. 5 is a flowchart of a process for determining a travel route according to the process of FIG. 2 and based on a rule that limits the number of recommended routes that pass through a constrained area. The process of FIG. 5 starts at step 500. In step 502, one or more route calculation rules 116 (see FIG. 1) are received and stored in a computer data storage unit. The computer data storage unit may be coupled to GPS 112 (see FIG. 1) or computer system 102 (see FIG. 1). The received route calculation rule(s) 116 (see FIG. 1) include a number of recommended routes-limiting rule that indicates that the number of recommended routes presented by multiple performances of steps 204-214 in the process of FIG. 2, where the recommended routes pass through a constrained area, is not permitted to exceed a predefined number X. As used herein, a constrained area is defined as a geographic area that is experiencing traffic congestion according to predefined criteria. In step 504, RCS 110 (see FIG. 1) receives an indication of a constrained area according to predefined criteria.

In step 506, the steps 204-214 in FIG. 2 are performed and may be repeated until N routes determined in step 212 (see FIG. 2) are recommended and presented in step 214 (see FIG. 2), where N≧1, and where each of the N recommended routes passes through the constrained area indicated in step 504.

In step 508, steps 204-212 in the process of FIG. 2 are performed to determine an (N+1)-th route that passes through the constrained area indicated in step 504.

If RCS 110 (see FIG. 1) determines in step 510 that N+1 is not greater than X, then the No branch of step 510 is taken and step 512 is performed. In step 512, RCS 110 (see FIG. 1) designates the (N+1)-th route determined in step 508 as the (N+1)-th recommended route. In step 514, the GPS 112 (see FIG. 1) presents (e.g., displays) the (N+1)-th recommended route to the user. The process of FIG. 5 ends at step 516.

Returning to step 510, if RCS 110 (see FIG. 1) determines that N+1 is greater than X, then in step 518 the RCS indicates that the (N+1)-th route determined in step 508 is not a recommended route and is not to be presented to the user. In one embodiment, step 518 indicates that the (N+1)-th route is not a recommended route and is not to be presented to the user in order to prevent a traffic jam in the constrained area. Following step 518, the process of FIG. 5 ends at step 516.

In an alternate embodiment, step 518 is replaced with (1) the RCS 110 (see FIG. 1) identifying the constrained area as having congested traffic based on the N recommended routes previously presented to users (or based on an indication received by the RCS in a previous step), (2) the RCS determining that the (N+1)-th route includes congested traffic, and (3) the RCS determining an additional fee to charge a vendor whose associated location is along the (N+1)-th route. The additional fee is added to the fee determined in step 210 (see FIG. 2). The additional fee is charged for proposing routes for any additional vehicles to travel through the congested area, thereby promoting environmental stewardship by potentially reducing the number of additional vehicles entering the congested area.

### Computer System

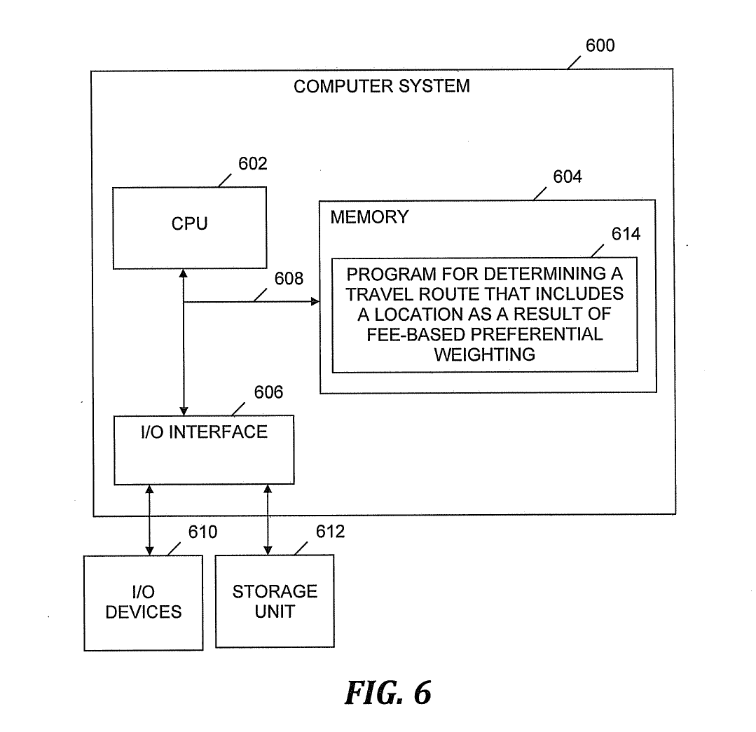

FIG. 6 is a computer system that is included in the system of FIG. 1, implements the process of FIG. 2, and may optionally implement one or more of the processes of FIG. 3, FIG. 4 and FIG. 5, in accordance with embodiments of the present invention. Computer system 600 generally comprises a central processing unit (CPU) 602, a memory 604, an input/output (I/O) interface 606, and a bus 608. Further, computer system 600 is coupled to I/O devices 610 and a computer data storage unit 612. CPU 602 performs computation and control functions of computer system 600. CPU 602 may comprise a single processing unit, or be distributed across one or more processing units in one or more locations (e.g., on a client and server). In one embodiment, computer system 600 implements RCS 110 (see FIG. 1) and may reside in vehicle 108 (see FIG. 1). In one embodiment, computer system 600 is GPS 112 (see FIG. 1).

Memory 604 may comprise any known computer readable storage medium, which is described below. In one embodiment, cache memory elements of memory 604 provide temporary storage of at least some program code (e.g., program code 614) in order to reduce the number of times code must be retrieved from bulk storage while instructions of the program code are carried out. Moreover, similar to CPU 602, memory 604 may reside at a single physical location, comprising one or more types of data storage, or be distributed across a plurality of physical systems in various forms. Further, memory 604 can include data distributed across, for example, a local area network (LAN) or a wide area network (WAN).

I/O interface 606 comprises any system for exchanging information to or from an external source. I/O devices 610 comprise any known type of external device, including a display device (e.g., monitor), keyboard, mouse, printer, speakers, handheld device, facsimile, etc. Bus 608 provides a communication link between each of the components in computer system 600, and may comprise any type of transmission link, including electrical, optical, wireless, etc.

I/O interface 606 also allows computer system 600 to store and retrieve information (e.g., data or program instructions such as program code 614) from an auxiliary storage device such as computer data storage unit 612 or another computer data storage unit (not shown). Computer data storage unit 612 may comprise any known computer readable storage medium, which is described below. For example, computer data storage unit 612 may be a non-volatile data storage device, such as a magnetic disk drive (i.e., hard disk drive) or an optical disc drive (e.g., a CD-ROM drive which receives a CD-ROM disk).

Memory 604 may include computer program code 614 that provides the logic for determining a travel route that includes a location as a result of fee-based preferential weighting (e.g., the process of FIG. 2). Further, memory 604 may include other systems not shown in FIG. 6, such as an operating system (e.g., Linux) that runs on CPU 602 and provides control of various components within and/or connected to computer system 600.

Memory 604, storage unit 612, and/or one or more other computer data storage units (not shown) that are coupled to computer system 600 may store a database (e.g., central database 104 in FIG. 1). The database stored by storage unit 612 may include user profile data 114 (see FIG. 1) and/or route calculation rules 116 (see FIG. 1).

As will be appreciated by one skilled in the art, the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “module” or “system” (e.g., system 100 in FIG. 1 or computer system 600). Furthermore, an embodiment of the present invention may take the form of a computer program product embodied in one or more computer readable medium(s) (e.g., memory 604 or computer data storage unit 612) having computer readable program code (e.g., program code 614) embodied or stored thereon.

Any combination of one or more computer readable medium(s) (e.g., memory 604 and computer data storage unit 612) may be utilized. The computer readable medium may be a computer readable signal medium or a computer readable storage medium. A computer readable storage medium may be, for example, but not limited to, an electronic, magnetic, optical, electromagnetic, infrared or semiconductor system, apparatus, device or any suitable combination of the foregoing. A non-exhaustive list of more specific examples of the computer-readable storage medium includes: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with a system, apparatus, or device for carrying out instructions.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with a system, apparatus, or device for carrying out instructions.

Program code (e.g., program code 614) embodied on a computer readable medium may be transmitted using any appropriate medium, including but not limited to wireless, wireline, optical fiber cable, RF, etc., or any suitable combination of the foregoing.

Computer program code (e.g., program code 614) for carrying out operations for aspects of the present invention may be written in any combination of one or more programming languages, including an object oriented programming language such as Java®, Smalltalk, C++ or the like and conventional procedural programming languages, such as the “C” programming language or similar programming languages. Instructions of the program code may be carried out entirely on a user's computer, partly on the user's computer, as a stand-alone software package, partly on the user's computer and partly on a remote computer or entirely on the remote computer or server, where the aforementioned user's computer, remote computer and server may be, for example, computer system 600 or another computer system (not shown) having components analogous to the components of computer system 600 included in FIG. 6. In the latter scenario, the remote computer may be connected to the user's computer through any type of network (not shown), including a LAN or a WAN, or the connection may be made to an external computer (e.g., through the Internet using an Internet Service Provider).

Aspects of the present invention are described herein with reference to flowchart illustrations (e.g., FIGS. 2-5) and/or block diagrams of methods, apparatus (systems) (e.g., FIG. 1 and FIG. 6), and computer program products according to embodiments of the invention. It will be understood that each block of the flowchart illustrations and/or block diagrams, and combinations of blocks in the flowchart illustrations and/or block diagrams, can be implemented by computer program instructions (e.g., program code 614). These computer program instructions may be provided to a processor (e.g., CPU 602) of a general purpose computer, special purpose computer, or other programmable data processing apparatus to produce a machine, such that the instructions, which are carried out via the processor of the computer or other programmable data processing apparatus, create means for implementing the functions/acts specified in the flowchart and/or block diagram block or blocks.

These computer program instructions may also be stored in a computer readable medium (e.g., memory 604 or computer data storage unit 612) that can direct a computer (e.g., computer system 600), other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer (e.g., computer system 600), other programmable data processing apparatus, or other devices to cause a series of operational steps to be performed on the computer, other programmable apparatus, or other devices to produce a computer implemented process such that the instructions which are carried out on the computer, other programmable apparatus, or other devices provide processes for implementing the functions/acts specified in the flowchart and/or block diagram block or blocks.

Any of the components of an embodiment of the present invention can be deployed, managed, serviced, etc. by a service provider that offers to deploy or integrate computing infrastructure with respect to the process of determining a travel route that includes a location as a result of fee-based preferential weighting. Thus, an embodiment of the present invention discloses a process for supporting computer infrastructure, comprising integrating, hosting, maintaining and deploying computer-readable code (e.g., program code 614) into a computer system (e.g., computer system 600), wherein the code in combination with the computer system is capable of performing a process of determining a travel route that includes a location as a result of fee-based preferential weighting.

In another embodiment, the invention provides a business method that performs the process steps of the invention on a subscription, advertising and/or fee basis. That is, a service provider, such as a Solution Integrator, can offer to create, maintain, support, etc. a process of determining a travel route that includes a location as a result of fee-based preferential weighting. In this case, the service provider can create, maintain, support, etc. a computer infrastructure that performs the process steps of the invention for one or more customers. In return, the service provider can receive payment from the customer(s) under a subscription and/or fee agreement, and/or the service provider can receive payment from the sale of advertising content to one or more third parties.

The flowcharts in FIGS. 2-5 and the block diagrams in FIG. 1 and FIG. 6 illustrate the architecture, functionality, and operation of possible implementations of systems, methods, and computer program products according to various embodiments of the present invention. In this regard, each block in the flowchart or block diagrams may represent a module, segment, or portion of code (e.g., program code 614), which comprises one or more executable instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

What is claimed is:

1. A computer-implemented method of determining a route that includes a location according to a fee charged to an entity associated with the location, said method comprising:
receiving a request from a user for a determination of a route from a first point to a second point;
assigning a preferential weight to a location associated with a vendor;
selecting said location as being capable of being included along said route, wherein said selecting said location is based on said request and said preferential weight;
determining a fee to be charged to said vendor for presenting said route to said user as a recommended route, wherein said fee is based on said location being included along said recommended route;
a processor of a computer system determining said route so that said location is included along said route; and
presenting said determined route to said user as said recommended route.

2. The method of claim 1, further comprising:
tracking an actual route traveled by said user subsequent to said presenting said determined route;
determining that said location is included along said actual route; and
responsive to said determining that said location is included along said actual route, determining an additional fee to be charged to said vendor.

3. The method of claim 1, further comprising:
retrieving a rule indicating that a first length of said recommended route is not permitted to exceed a second length of an optimal route from said first point to said second point by more than X percent;
determining said first length is N percent more than said second length;
determining said N percent is not greater than said X percent; and
in response to said determining said N percent is not greater than said X percent, designating said determined route as said recommended route.

4. The method of claim 1, further comprising:
receiving a second request from a second user for a determination of a second route from a third point to a fourth point;
assigning a second preferential weight to a second location associated with a second vendor;
selecting said second location as being capable of being included along said second route, wherein said selecting said second location is based on said second request and said second preferential weight;
determining a second fee to be charged to said second vendor for presenting said second route to said second user as a second recommended route, wherein said second fee is based on said second location being included along said second recommended route;
determining said second route so that said second location is included along said second route;
retrieving a rule indicating that a first length of said second route is not permitted to exceed a second length of a second optimal route from said third point to said fourth point by more than X percent;
determining said first length of said second route is N percent more than said second length of said second optimal route;
determining said N percent is greater than said X percent; and
in response to said determining said N percent is greater than said X percent, indicating said second route is not recommended to said second user and is not to be presented to said second user.

5. The method of claim 1, further comprising:
retrieving a rule indicating that a first number of recommended routes that pass through a constrained area is not permitted to exceed a second number;
receiving an indication of said constrained area;
presenting N recommended routes subsequent to a receipt of N requests for N routes, wherein said N recommended routes pass through said constrained area, and wherein said presenting said N recommended routes includes said presenting said determined route to said user as said recommended route;
determining an (N+1)-th route that passes through said constrained area, wherein said determining said (N+1)-th route is based on a receipt of a request from a second user for a determination of said (N+1)-th route;
determining said first number is not greater than said second number, wherein said first number is said N+1;
in response to said determining said first number is not greater than said second number, designating said (N+1)-th route as an (N+1)-th recommended route.

6. The method of claim 1, further comprising:
retrieving a rule indicating that a first number of recommended routes that pass through a constrained area is not permitted to exceed a second number;
receiving an indication of said constrained area;
presenting N recommended routes subsequent to a receipt of N requests for N routes, wherein said N recommended routes pass through said constrained area, and wherein said presenting said N recommended routes includes said presenting said determined route to said user as said recommended route;
determining an (N+1)-th route that passes through said constrained area, wherein said determining said (N+1)-th route is based on a receipt of a request from a second user for a determination of said (N+1)-th route;
determining said first number is greater than said second number, wherein said first number is said N+1;
in response to said determining said first number is greater than said second number, indicating that said (N+1)-th route is not a recommended route and is not to be presented to said second user.

7. The method of claim 1, further comprising retrieving profile data that describes one or more behaviors of said user, wherein said selecting said location is further based on said profile data.

8. The method of claim 7, wherein said profile data includes a preference of said user for purchasing a good or a service.

9. The method of claim 1, further comprising receiving a user-specified service or a user-specified product, wherein said determining said route includes identifying a second location as providing said user-specified service or said user-specified product, wherein said second location is included along said route, and wherein said second location is different from said location associated with said vendor.

10. The method of claim 1, further comprising compensating said user or a third party in response to said presenting said determined route to said user as said recommended route, wherein said compensating includes providing an incentive to said user to participate in said method.

11. A computer system comprising a processor coupled to a computer-readable memory unit, said memory unit comprising a software application, said software application comprising instructions that when carried out by said processor implement the method of claim 1.

12. A computer program product, comprising a computer readable storage medium having a computer readable program code stored therein, said computer readable program code containing instructions executable by a processor of a computer system to implement a method of determining a route that includes a location according to a fee charged to an entity associated with the location, said method comprising:
receiving a request from a user for a determination of a route from a first point to a second point;
assigning a preferential weight to a location associated with a vendor;
selecting said location as being capable of being included along said route, wherein said selecting said location is based on said request and said preferential weight;
determining a fee to be charged to said vendor for presenting said route to said user as a recommended route, wherein said fee is based on said location being included along said recommended route;
determining said route so that said location is included along said route; and
presenting said determined route to said user as said recommended route.

13. The program product of claim 12, wherein said method further comprises:
tracking an actual route traveled by said user subsequent to said presenting said determined route;
determining that said location is included along said actual route; and
responsive to said determining that said location is included along said actual route, determining an additional fee to be charged to said vendor.

14. The program product of claim 12, wherein said method further comprises:
retrieving a rule indicating that a first length of said recommended route is not permitted to exceed a second length of an optimal route from said first point to said second point by more than X percent;
determining said first length is N percent more than said second length;
determining said N percent is not greater than said X percent; and
in response to said determining said N percent is not greater than said X percent, designating said determined route as said recommended route.

15. The program product of claim 12, wherein said method further comprises:
receiving a second request from a second user for a determination of a second route from a third point to a fourth point;
assigning a second preferential weight to a second location associated with a second vendor;
selecting said second location as being capable of being included along said second route, wherein said selecting said second location is based on said second request and said second preferential weight;
determining a second fee to be charged to said second vendor for presenting said second route to said second user as a second recommended route, wherein said second fee is based on said second location being included along said second recommended route;
determining said second route so that said second location is included along said second route;
retrieving a rule indicating that a first length of said second route is not permitted to exceed a second length of a second optimal route from said third point to said fourth point by more than X percent;
determining said first length of said second route is N percent more than said second length of said second optimal route;
determining said N percent is greater than said X percent; and
in response to said determining said N percent is greater than said X percent, indicating said second route is not recommended to said second user and is not to be presented to said second user.

16. The program product of claim 12, wherein said method further comprises:
retrieving a rule indicating that a first number of recommended routes that pass through a constrained area is not permitted to exceed a second number;
receiving an indication of said constrained area;
presenting N recommended routes subsequent to a receipt of N requests for N routes, wherein said N recommended routes pass through said constrained area, and wherein said presenting said N recommended routes includes said presenting said determined route to said user as said recommended route;
determining an (N+1)-th route that passes through said constrained area, wherein said determining said (N+1)-th route is based on a receipt of a request from a second user for a determination of said (N+1)-th route;
determining said first number is not greater than said second number, wherein said first number is said N+1;
in response to said determining said first number is not greater than said second number, designating said (N+1)-th route as an (N+1)-th recommended route.

17. The program product of claim 12, wherein said method further comprises:
retrieving a rule indicating that a first number of recommended routes that pass through a constrained area is not permitted to exceed a second number;
receiving an indication of said constrained area;
presenting N recommended routes subsequent to a receipt of N requests for N routes, wherein said N recommended routes pass through said constrained area, and wherein said presenting said N recommended routes includes said presenting said determined route to said user as said recommended route;
determining an (N+1)-th route that passes through said constrained area, wherein said determining said (N+1)-th route is based on a receipt of a request from a second user for a determination of said (N+1)-th route;
determining said first number is greater than said second number, wherein said first number is said N+1;
in response to said determining said first number is greater than said second number, indicating that said (N+1)-th route is not a recommended route and is not to be presented to said second user.

18. A process for supporting computing infrastructure, said process comprising providing at least one support service for at least one of creating, integrating, hosting, maintaining, and deploying computer-readable code in a computing system comprising a processor, wherein said processor carries out instructions of said code to cause the computing system to specify a method of determining a route that includes a location according to a fee charged to an entity associated with the location, said method comprising:
receiving a request from a user for a determination of a route from a first point to a second point;
assigning a preferential weight to a location associated with a vendor;
selecting said location as being capable of being included along said route, wherein said selecting said location is based on said request and said preferential weight;
determining a fee to be charged to said vendor for presenting said route to said user as a recommended route, wherein said fee is based on said location being included along said recommended route;
determining said route so that said location is included along said route; and
presenting said determined route to said user as said recommended route.

19. The process of claim 18, wherein said method further comprises:
tracking an actual route traveled by said user subsequent to said presenting said determined route;
determining that said location is included along said actual route; and
responsive to said determining that said location is included along said actual route, determining an additional fee to be charged to said vendor.

20. The process of claim 18, wherein said method further comprises:
retrieving a rule indicating that a first length of said recommended route is not permitted to exceed a second length of an optimal route from said first point to said second point by more than X percent;
determining said first length is N percent more than said second length;
determining said N percent is not greater than said X percent; and
in response to said determining said N percent is not greater than said X percent, designating said determined route as said recommended route.
